(19) United States
(12) Patent Application Publication
(10) Pub. No.: US 2008/0293487 A1
(43) Pub. Date: Nov. 27, 2008

(54) Game Device, Game Device Control Method, and Information Storage Medium

(75) Inventor: Shinsaku Inukai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KONAMI DIGITAL ENTERTAINMENT CO., LTD., Tokyo (JP)

(21) Appl. No.: 11/794,107

(22) PCT Filed: Dec. 19, 2005
(86) PCT No.: PCT/JP05/23296

§ 371 Date: Jun. 25, 2007

(30) Foreign Application Priority Data
Jan. 4, 2005 (JP) 2005-000108

(51) Int. Cl. A63F 9/24; G06F 17/00

(52) U.S. Cl. 463/31; 463/43

(57) ABSTRACT

To provide a game device capable of increasing the unpredictability of a change given to an image displayed on a game screen and suitably expressing how the image returns to an original state. The present invention relates to the game device for displaying an image including a plurality of element images on the game screen. Each time a predetermined display restriction condition is satisfied, at least one of the element images displayed on the game screen is selected based on a random number and display of the selected element image is restricted. Moreover, sequence information indicating the order of the restriction of the display of the element image is stored by correlating it to the element image whose display is limited. The display restriction of the element image is reset based on the sequence information.

### TECHNICAL FIELD

The present invention relates to a game device, a control method for a game device, and an information storage medium.

### BACKGROUND ART

There is known a game device which can change an image shown on a game screen in response to the occurrence of a predetermined game event. For example, there is known a game device which can change the shape of an object to be operated by a player in response to the occurrence of a predetermined game event.

### [Patent Document 1] JP 09-231409 A

### DISCLOSURE OF THE INVENTION

### Problems to be Solved by the Invention

It is strongly desired for the game device as describe above to increase unpredictability of a change in an image so as not to bore a player, and to suitably express the image returning to an original state.

The present invention has been made in view of the above-mentioned problem, and an object of the present invention is to provide a game device, a control method for a game device, and an information recording medium which increase unpredictability of a change in an image shown on a game screen, and suitably express the image returning to an original state.

### Means for Solving the Problems

In order to achieve the above-mentioned object, according to the present invention, there is provided a game device for displaying an image including a plurality of element images on a game screen, the game device including: display restriction means for selecting at least one of the element images shown on the game screen based on a random number in response to the occurrence of a predetermined game event, and restricting display of the selected element image; sequence information storage means for storing sequence information indicating a sequence of the restriction of the element image whose display is restricted by the display restriction means in association with the element image; and display restriction resetting means for resetting the display restriction by the display restriction means based on the sequence information stored in the sequence information storage means.

According to another aspect of the present invention, there is provided a control method for a game device for displaying an image including a plurality of element images on a game screen, the control method including: a display restriction step of selecting at least one of the element images shown on the game screen based on a random number in response to the occurrence of a predetermined game event, and restricting display of the selected element image; a sequence information storage step of storing sequence information, indicating a sequence for the restriction of the element image whose display is restricted by the display restriction step, in storage means in association with the element image; and a display restriction resetting step of selecting at least one of the element images whose display is restricted by the display restriction step based on the sequence information stored in the storage means, and resetting the display restriction applied to the element image.

According to still another aspect of the present invention, there is provided a program for causing a computer such as a home game machine, a portable game machine, a commercial game machine, a cellular phone, a personal digital assistant (PDA), or a personal computer to function as a game device which displays an image including a plurality of element images on a game screen, and also to function as display restriction means for selecting at least one of the element images shown on the game screen based on a random number in response to the occurrence of a predetermined game event, and restricting display of the selected element image, sequence information storage means for storing sequence information, indicating a sequence for the restriction of the element image whose display is restricted by the display restriction means, in association with the element image, and display restriction resetting means for resetting the display restriction by the display restriction means based on the sequence information stored in the sequence information storage means.

According to yet another aspect of the present invention, there is provided a computer-readable information storage medium storing the above program. Moreover, a program distribution device according to the present invention is a program distribution device which includes an information storage medium storing the above program, reads out the program from the information storage medium, and distributes the program. Moreover, a program distribution method according to the present invention is a program distribution method, while using an information storage medium storing the above program, for reading out the program from the information storage medium, and distributing the program.

According to the present invention, an image including a plurality of element images is shown on the game screen. Moreover, at least one of the element images shown on the game screen is selected based on a random number in response to the occurrence of a predetermined game event, and display of the selected element image is restricted. Sequence information indicating a sequence of the restriction of an element image whose display is restricted is stored in association with this element image. The display restriction applied to the element image is reset based on the sequence information. The present invention increases unpredictability of a change in an image shown on the game screen, and suitably expresses the image returning to an original state.

In one example of the present invention, the display restriction resetting means may reset the display restriction by the display restriction means further based on a random number. In this way, it is possible to give variety to the reset of the display restriction.

In another example of the present invention, the game device includes numerical information storage means for storing numerical information which is decreased in response to the occurrence of the predetermined game event, where the display restriction means selects at least one of the element images shown on the game screen according to decrease of the numerical information based on a random number, and restricts display of the selected element image, and the display restriction resetting means resets the display restriction by the display restriction means according to increase of the numerical information. With this structure, a player can recognize the state of the numerical information at a glance by referring to the image.

In still another example of the present invention, the game device includes numerical information storage means for storing numerical information which is increased in response to the occurrence of the predetermined game event, where the display restriction means selects at least one of the element images shown on the game screen according to increase of the numerical information based on a random number, and restricts display of the selected element image, and the display restriction resetting means resets the display restriction by the display restriction means according to decrease of the numerical information. With this structure, a player can recognize the state of the numerical information at a glance by referring to the image.

In still another example of the present invention, the number of element images which are selected from element images shown on the game screen based on a random number by the display restriction means corresponds to increase or decrease of the numerical information.

In yet another example of the present invention, an operation object image is shown on the game screen, and the image may be shown at a position based on the position of the operation object image. With this structure, a player can recognize the state of the numerical information at a glance by referring to the state of the image during operation while paying attention to the operation object image.

### BRIEF DESCRIPTION OF THE DRAWINGS

FIG. 1 shows a structure of a game device according to an embodiment.

FIG. 2 shows an example of a controller.

FIG. 3 shows an example of a three-dimensional game screen.

FIG. 4 shows a structure of a shield object.

FIG. 5 shows an example of the game screen.

FIG. 6 shows an example of the game screen.

FIG. 7 shows an example of the game screen.

FIG. 8 shows an example of the game screen.

FIG. 9 shows functional blocks of the game device according to this embodiment.

FIG. 10 shows an example of available defense remaining number data.

FIG. 11 shows an example of shield element management data.

FIG. 12 shows an example of elapsed time counter data.

FIG. 13 is a flowchart of a process carried out by the game device.

FIG. 14 shows a continued part of the flowchart of the process carried out by the game device.

FIG. 15 shows a continued part of the flowchart of the process carried out by the game device.

FIG. 16 shows an overall structure of a program distribution system according to another embodiment of the present invention.

### BEST MODE FOR CARRYING OUT THE INVENTION

A detailed description will now be given of embodiments of the present invention with reference to drawings.

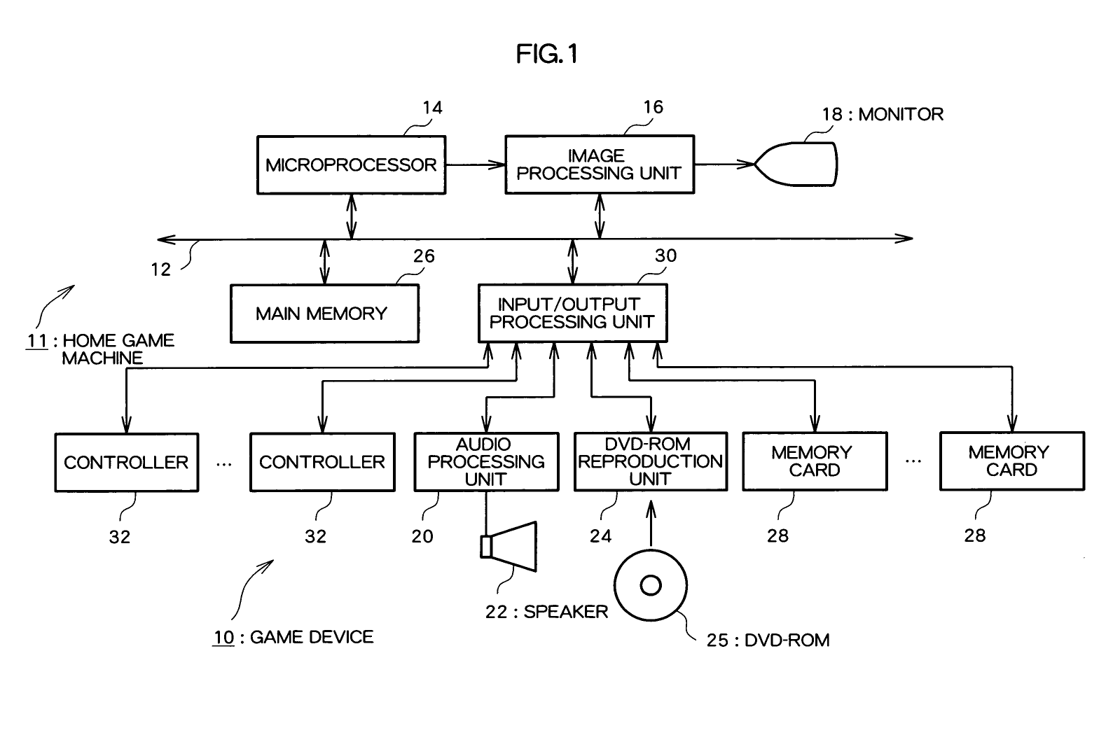

FIG. 1 shows a structure of a game device according to an embodiment of the present invention. A game device 10 shown in FIG. 1 is constituted by mounting a DVD-ROM 25 and a memory card 28 as information recording media on a home game machine 11, and connecting a monitor 18 and a speaker 22 thereto. For example, a home television receiver is used as the monitor 18, and speakers integrated thereinto are used as the speaker 22.

The home game machine 11 is a publicly known computer game system constituted by including a bus 12, a microprocessor 14, an image processing unit 16, an audio processing unit 20, a DVD-ROM reproduction unit 24, a main memory 26, an input/output processing unit 30, and a controller 32. The components other than the controller 32 are contained in a housing.

The bus 12 communicates addresses and data between the respective units of the home game machine 11. The microprocessor 14, the image processing unit 16, the main memory 26, and the input/output processing unit 30 are connected via the bus 12 so as to mutually communicate data.

The microprocessor 14 controls the respective units of the home game machine 11 based on an operating system stored in a ROM, which is not shown, a program read out from the DVD-ROM 25, and data read out from the memory card 28. The main memory 26 is constituted by including a RAM, for example, and the program read out from the DVD-ROM 25 and the data read out from the memory card 28 are written therein as required. The main memory 26 is also used as a work area for the microprocessor 14.

The image processing unit 16 is constituted by including a VRAM, and draws a game screen on the VRAM based on image data transferred from the microprocessor 14. The image processing unit 16 converts contents of the game screen into a video signal, and outputs the video signal to the monitor 18 at a predetermined timing.

The input/output processing unit 30 is an interface for the microprocessor 14 to access the audio processing unit 20, the DVD-ROM reproduction unit 24, the memory card 28, and the controller 32. The audio processing unit 20, the DVD-ROM reproduction unit 24, the memory card 28, and the controller 32 are connected to the input/output processing unit 30.

The audio processing unit 20 is constituted by including a sound buffer, and reproduces various audio data such as game music, game sound effects, and messages, which are readout from the DVD-ROM 25, and are stored in the sound buffer, and outputs them from the speaker 22.

The DVD-ROM reproducing unit 24 reads out a program stored in the DVD-ROM 25 according to an instruction from the microprocessor 14. Though the DVD-ROM 25 is used to supply the home game machine 11 with a program, any other information storage media such as a CD-ROM and a ROM card may be used. Moreover, a program may be supplied to the home game machine 11 from a remote site via a data communication network such as the Internet.

The memory card 28 is constituted by including a non-volatile memory (such as EEPROM). The home game machine 11 includes a plurality of memory card slots for inserting the memory cards 28, and a plurality of memory cards 28 may be inserted at the same time. The memory card 28 is configured so as to be detachably attached to the memory card slot, and is used to store various game data such as saved data.

The controller 32 is general purpose operation input means used to input various game operations by a player. The input/output processing unit 30 scans states of respective units of the controller 32 at a predetermined interval (for example, every 1/60 second), and passes an operation signal representing a result of the scan to the microprocessor 14 via the bus 12. The microprocessor 14 determines the game operation of the player based on the operation signal. The home game machine 11 is configured so as to be connected to a plurality of controllers 32, and the microprocessor 14 controls a game based on the operation signals input from the respective controllers 32.

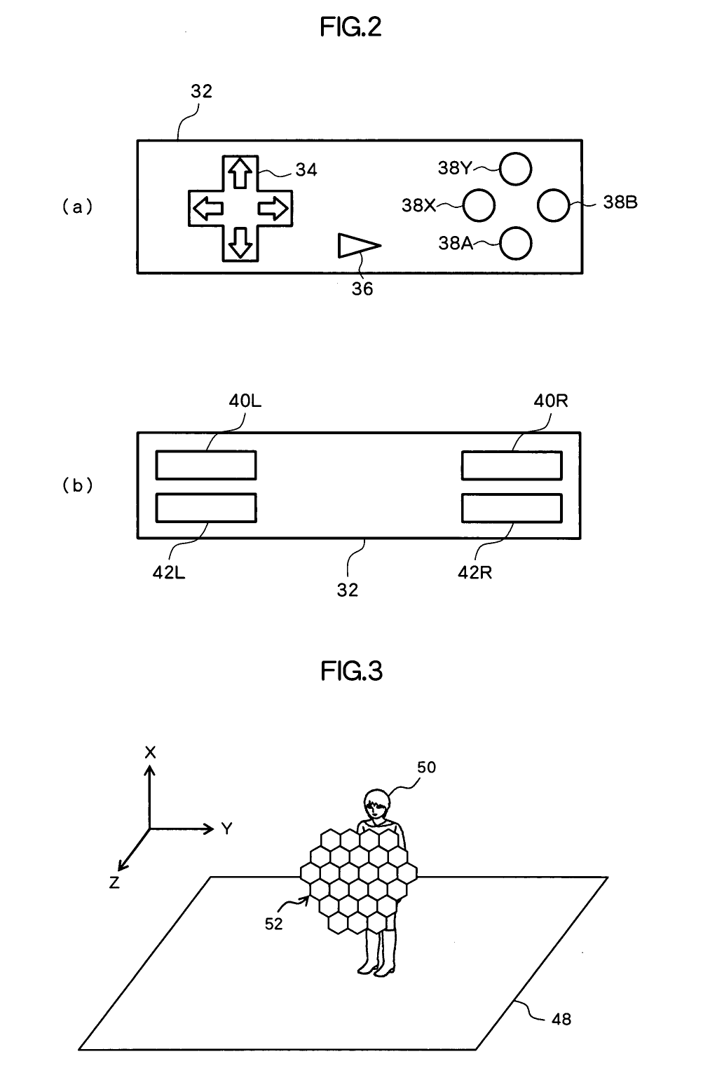

FIG. 2 shows an example of the controller 32. The controller 32 shown in FIG. 2 is a general purpose game controller. As shown in FIG. 2(a), a direction button 34, a start button 36, and buttons 38X, 38Y, 38A, and 38B are provided on a surface of the controller 32. Moreover, as shown in FIG. 2(b), buttons 42L and 42R are provided respectively left and right on a top surface of a back surface of the controller 32, and buttons 40L and 40R are provided respectively left and right on a bottom surface of the back surface of the controller 32. The direction button 34 has a cross shape, and is usually used to set a direction to move a character or cursor. The start button 36 is a small triangular push button, and is usually used to start or forcibly terminate a game. The buttons 38X, 38Y, 38A, 38B, 40L, 40R, 42L, and 42R are used for other game operations.

The game device 10 configured as described above provides a three-dimensional action game, in which a game program provided from the DVD-ROM 25 is executed, and the player conquers various game events while operating a player character (game character to be operated by the player) to avoid a hit point, which decreases with attack by an enemy character, from becoming zero.

A three-dimensional game space (virtual three dimensional space) where objects such as a player character and an enemy character are arranged is constructed in the main memory 26 of the game device 10 as a result of the execution of the game program. A picture obtained by viewing the three-dimensional game space from a given viewpoint (for example, a viewpoint following the player character) is then shown on the monitor 18. The player operates the controller 32 while watching the game screen to give various action instructions such as a move instruction, an attack instruction, and a defense instruction to the player character.

In this three-dimensional action game, if an attack of the enemy character hits the player character, the hit point of the player character generally decreases. Even if an attack of the enemy character hits the player character, when the player carries out an operation to instruct defense (defense operation), the hit point does not decrease.

It should be noted that an available number to make the attack of the enemy character ineffective (available defense number) by means of the defense operation is restricted. More specifically, a remaining number of available defense (available defense remaining number) is initially three, and is decreased each time the attack of the enemy character is made ineffective. Types of attack of the enemy character include a normal type and a special type, and if the normal attack is made ineffective by the defense operation, the available defense remaining number is decreased by one, and if the special attack is made ineffective by the defense operation, the available defense remaining number is set to zero. Moreover, each time a predetermined time elapses while an attack of the enemy character is not being made ineffective, the available defense remaining number increases by one. It should be noted that the available defense remaining number does not exceed the initial value (three). The player always plays the game while considering this available defense remaining number.

FIG. 3 shows an example of the three-dimensional game space constructed in the main memory 26. As shown in FIG. 3, a ground object 48, a player character 50 (player character object), and a shield object 52 are arranged in the three-dimensional game space. Though an enemy character object and the like are arranged in the three-dimensional game space in addition to the above-mentioned objects, a description thereof is omitted here.

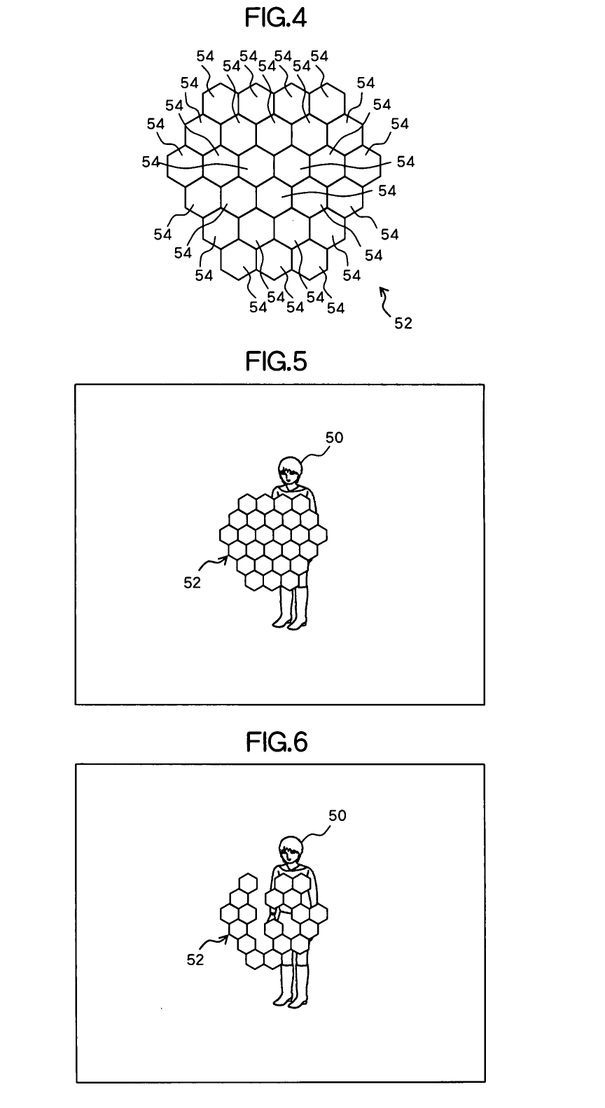

The shield object 52 is arranged at a position determined based on a position of the player character 50 (more specifically a predetermined position in front of the player character 50). Namely, the shield object 52 is arranged so as to follow the player character 50. Moreover, the shield object 52 is constituted by including 27 shield element objects 54 as shown in FIG. 4. In other words, the shield object 52 is an aggregate of the 27 shield element objects 54 (aggregate object). That is, the one shield object 52 is formed by disposing the 27 shield element objects 54 at a position based on the position of the player character 50 in a predetermined arrangement.

All or some of the shield element objects 54 are set to be transparent according to the decrease of the available defense remaining number in the game device 10. Moreover, the whole or a part of the shield element objects 54 which are set to be transparent are restored to opaque according to an increase of the available defense remaining number. A detailed description will now be given of this point.

FIGS. 5 to 8 show examples of the game screen shown on the monitor 18. As shown in FIGS. 5 to 8, the player character 50 (more specifically, an image representing a state of the player character 50 viewed from a given viewpoint) and the shield object 52 (more specifically, an image representing a state of the shield object 52 viewed from the given viewpoint) are displayed on the game screen. It should be noted that the shield object 52 (shield element objects 54) is shown on the game screen only when the player is carrying out a defense operation.

FIG. 5 shows a game screen when the player carries out the defense operation when the available defense remaining number is three. On this occasion, all the shield element objects 54 are set to opaque, and the shield object 52 is displayed in full form on the game screen.

If the offence of the enemy character is made ineffective by the defense operation when the available defense remaining number is three, the available defense remaining number is updated to two. On this occasion, nine shield element objects 54 are selected based on random numbers, and these shield element objects 54 are set to be transparent. FIG. 6 shows an example of a game screen when the player carries out the defense operation on this occasion. As shown in FIG. 6, the shield object 52 is shown in a form as if a part thereof is damaged on the game screen.

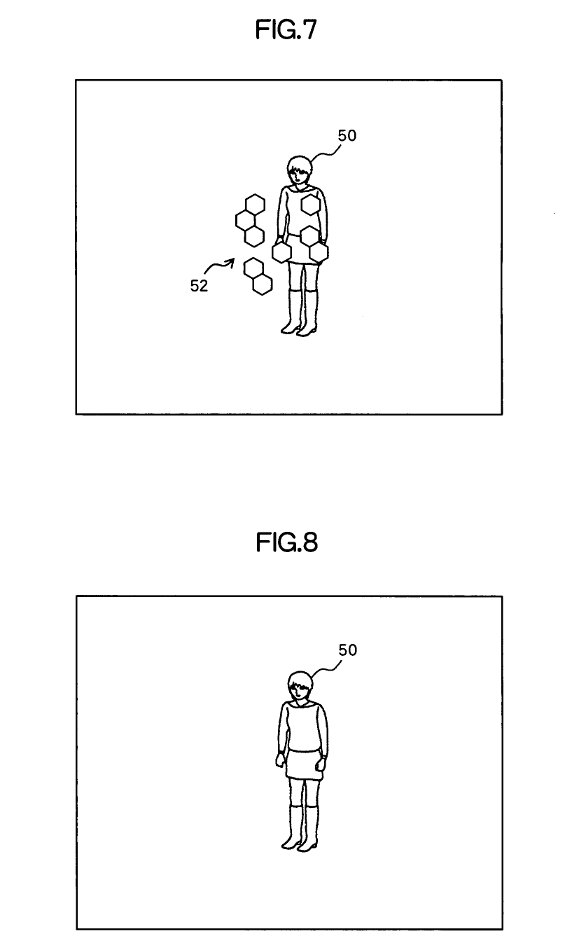

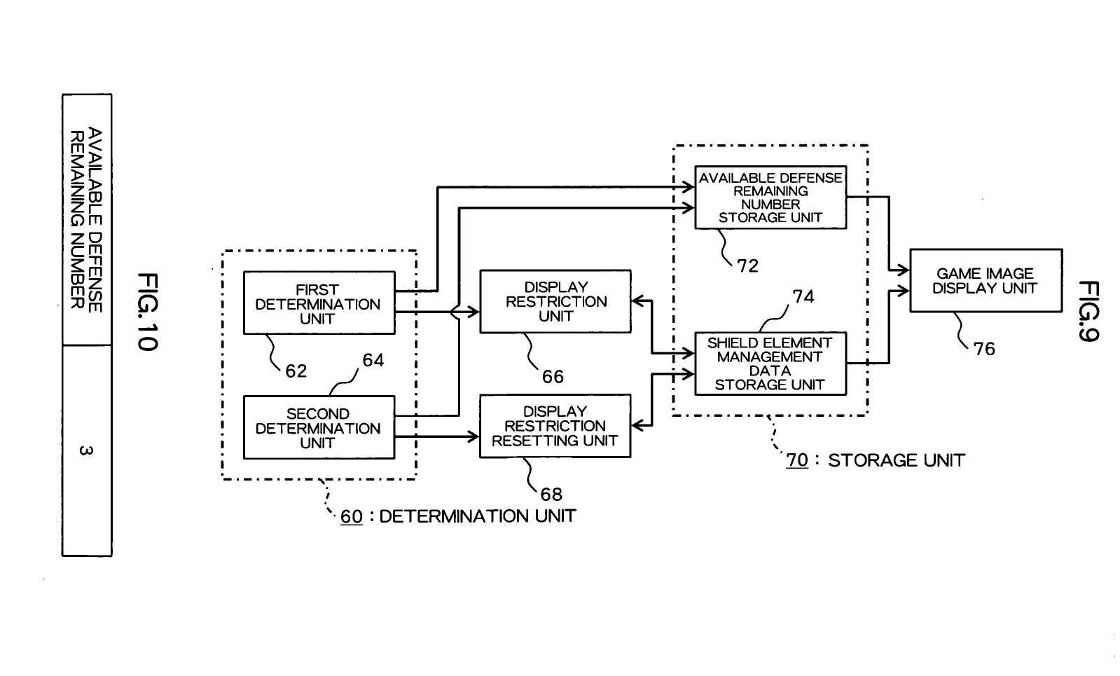

If the offence of the enemy character is made ineffective by the defense operation when the available defense remaining number is two, the available defense remaining number is updated to one. On this occasion, nine shield element objects 54 are further selected based on random numbers from the shield element objects 54 which have not been set to transparent, and these shield element objects 54 are set to be transparent. FIG. 7 shows an example of the game screen when the player carries out the defense operation on this occasion. As shown in FIG. 7, the shield object 52 is shown in a form as if a part thereof is further damaged on the game screen.

If the offence of the enemy character is made ineffective by the defense operation when the available defense remaining number is one, the available defense remaining number is updated to zero. On this occasion, all the shield element objects 54 are set to be transparent. FIG. 8 shows an example of the game screen when the player carries out the defense operation on this occasion. In this case, even if the player carries out the defense operation, the shield object 52 is no longer shown on the game screen.

When the shield element objects 54 are set to be transparent, these shield element objects 54 are represented such that they are scattered on the game screen.

In this way, the shield object 52, which is damaged according to the decrease of the available defense remaining number, and recovers according to the increase of the available defense remaining number, is shown near the player character 50 on the game device 10. As a result, the player can recognize the available defense remaining number at a glance based on a damaged state of the shield object 52 during the operation while paying attention to the player character 50. Moreover, on the game device 10, the shield object 52 is not always damaged in the same manner, which does not bore the player.

As shown in FIGS. 5 to 8, when a state of the shield object 52 changes (the shield element objects 54 are set to be transparent), if the available defense remaining number is updated from 0 to 1, the shield element objects 54, which were set to be transparent when the available defense remaining number was updated from 1 to 0, are reset to an opaque state, and the shield object 52 of the state shown in FIG. 7 appears on the game screen. Moreover, if the available defense remaining number is updated from 1 to 2, the shield element objects 54, which were set to transparent when the available defense remaining number was updated from 2 to 1, are reset to an opaque state, and the shield object 52 of the state shown in FIG. 6 appears on the game screen. Then, if the available defense remaining number is updated from 2 to 3, the shield element objects 54, which were set to be transparent when the available defense remaining number was updated from 3 to 2, are reset to an opaque state, and the shield object 52 of the state shown in FIG. 5 appears on the game screen.

In this way, on the game device 10, though the shield object 52 is not always damaged in the same manner, a gradual recovery of the shield object 52 is properly expressed, which does not make the player feel uncomfortable.

FIG. 9 mainly shows functional blocks relating to the present invention among function blocks realized in the game device 10. As shown in FIG. 10, the game device 10 is constituted by including a determination unit 60, a display restriction unit 66, a display restriction resetting unit 68, a storage unit 70, and a game image display unit 76. These functions are realized when the game device 10 executes a program, which is supplied via a computer-readable information storage medium or a communication network.

### [1. Storage Unit]

The storage unit 70 is configured mainly by the main memory 26, and stores information on various parameters relating to the player character 50, and information on various other parameters relating to this game. For example, the storage unit 70 stores parameter information representing positions and poses of dynamic objects (such as the play character 50 and the enemy character) arranged in the three-dimensional game space. Moreover, the storage unit 70 stores parameter information such as hit points representing states of the player character 50 and the enemy character, for example.

### [1-1. Available Defense Remaining Number Storage Unit]

The storage unit 70 includes an available defense remaining number storage unit 72 (numerical information storage means). The available defense remaining number storage unit 72 stores available defense remaining number data shown in FIG. 10, for example. As described before, the available defense remaining number is the numerical information indicating the remaining number available for the defense operation to make the offense of the enemy character ineffective, and takes any one of four values: zero, one, two, and three. Moreover, the initial value of the available defense remaining number is three, and the value of the available defense remaining number decreases each time an event of making the offence of the enemy character ineffective (predetermined game event) occurs. Specifically, the value of the available defense remaining number decreases by one each time the normal offense of the enemy character is made ineffective by the defense operation, and is updated to zero if the special offense of the enemy character is made ineffective by the defense operation.

### [1-2. Shield Element Management Data Storage Unit]

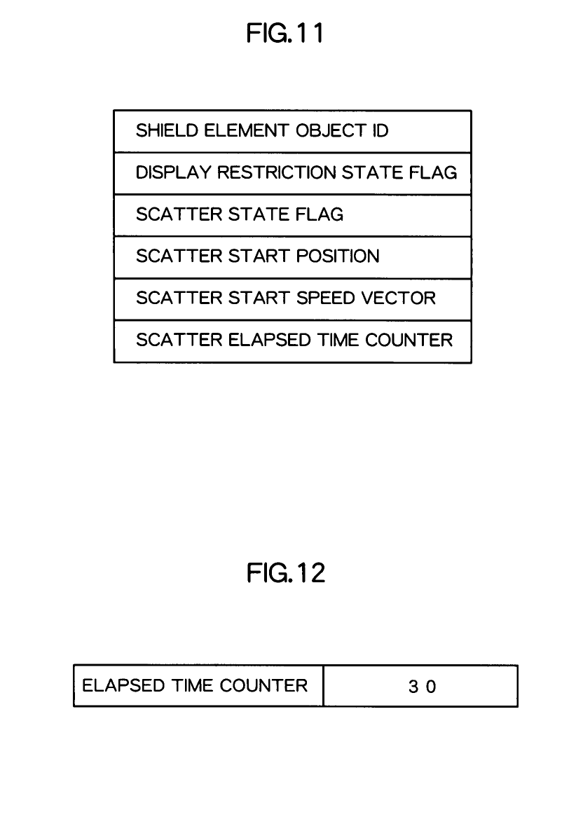

Moreover, the storage unit 70 includes a shield element management data storage unit 74 (sequence information storage means). The shield element management data storage unit 74 stores shield element management data having a data structure shown in FIG. 11, for example. As shown in FIG. 11, the shield element management data is constituted by including a shield element object ID, a display restriction state flag, a scatter state flag, a scatter start position, a scatter start speed vector, and a scatter elapsed time counter.

The shield element object ID is identification information for identifying each of the shield element objects 54.

The display restriction state flag is information indicating the display restriction state of each of the shield element objects 54. The display restriction state flag takes anyone of four values: zero, one, two, and three. The shield element object 54 whose display restriction state flag is zero is a shield element object 54 shown on the game screen. Moreover, the shield element object 54 whose display restriction state flag is one is a shield element object 54 whose display on the game screen was restricted (which was set to transparent) when the available defense remaining number was decreased to two. Similarly, the shield element object 54 whose display restriction state flag is two is a shield element object 54 whose display on the game screen was restricted when the available defense remaining number was decreased to one. Further, the shield element object 54 whose display restriction state flag is three is a shield element object 54 whose display on the game screen was restricted when the available defense remaining number was decreased to zero.

In other words, of the a plurality of shield element objects 54, the shield element objects 54 having a display restriction state flag of one are shield element objects 54 whose display was restricted first. Moreover, of the a plurality of shield element objects 54, the shield element objects 54 having a display restriction state flag of two are shield element objects 54 whose display was restricted secondarily. Further, of the a plurality of shield element objects 54, the shield element objects 54 having a display restriction state flag of three are shield element objects 54 whose display was restricted thirdly. Therefore, the display restriction state flag indicates whether the shield element object 54 is shown on the game screen (set to be transparent), and also serves as sequence information indicating the sequence of the display restriction for the shield element object 54 whose display on the game screen is restricted.

The scatter state flag, the scatter start position, the scatter start speed vector, and the scatter elapsed time counter are information providing effects of the scatter of the shield element objects 54 which transit to the state where the display on the game screen is restricted (state set to transparent) (scatter management information).

The scatter state flag is information indicating whether the scatter effect of the shield element object 54 is being provided. The scatter state flag is one when the scatter effect of the shield element object 54 is being provided, and zero when the effect is not being provided.

The scatter start position indicates an initial position of a scatter effect object for providing the scatter effect of the shield element object 54. Moreover, the scatter start speed vector indicates an initial speed vector of the scatter effect object corresponding to the shield element object 54. Further, the scatter elapsed time counter indicates an elapsed time since the scatter effect of the shield element object 54 started. The scatter elapsed time counter is numerical information representing the time by 1/60 seconds.

The shield element management data stores the above-described information on all the shield element objects 54.

### [2. Determination Unit]

The determination unit 60 determines whether a condition for updating information on respective parameters relating to this game is satisfied or not, and updates the contents of the respective parameter information according to a result of the determination. According to this embodiment, the determination unit 60 determines which of the increase condition or the decrease condition for the available defense remaining number stored in the available defense remaining number storage unit 72 is satisfied, and increases or decreases the available defense remaining number according to a result of the determination.

### [2-1. First Determination Unit]

The first determination unit 62 determines whether the decrease condition for the available defense remaining number is satisfied or not. The decrease condition for the available defense remaining number is whether the event which makes the offense of the enemy character ineffective has occurred or not. In other words, the decrease condition for the available defense remaining number is whether a) the offense of the enemy character hits the player character 50, b) the player carries out the defense operation, and c) the available defense remaining number stored in the available defense remaining number storage unit 72 is equal to or more than one. If the first determination unit 62 determines that the decrease condition for the available defense remaining number is satisfied, the first determination unit 62 decreases the available defense remaining number stored in the available defense remaining number storage unit 72. On this occasion, the first determination unit 62 decreases the available defense remaining number by one if the offense of the enemy character is the normal offense, and decreases the available defense remaining number to zero if the offense of the enemy character is the special offense. A detailed description will be given later (refer to steps S101 to S105, and S109 in FIG. 13).

### [2-2. Second Determination Unit]

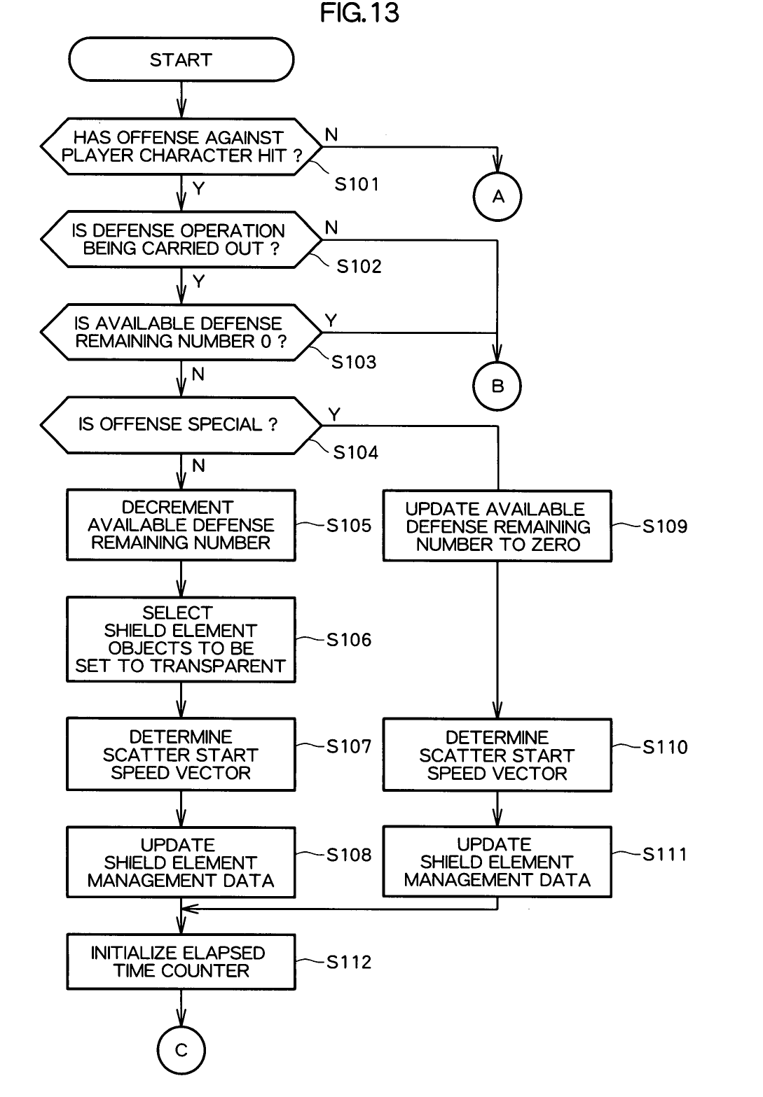

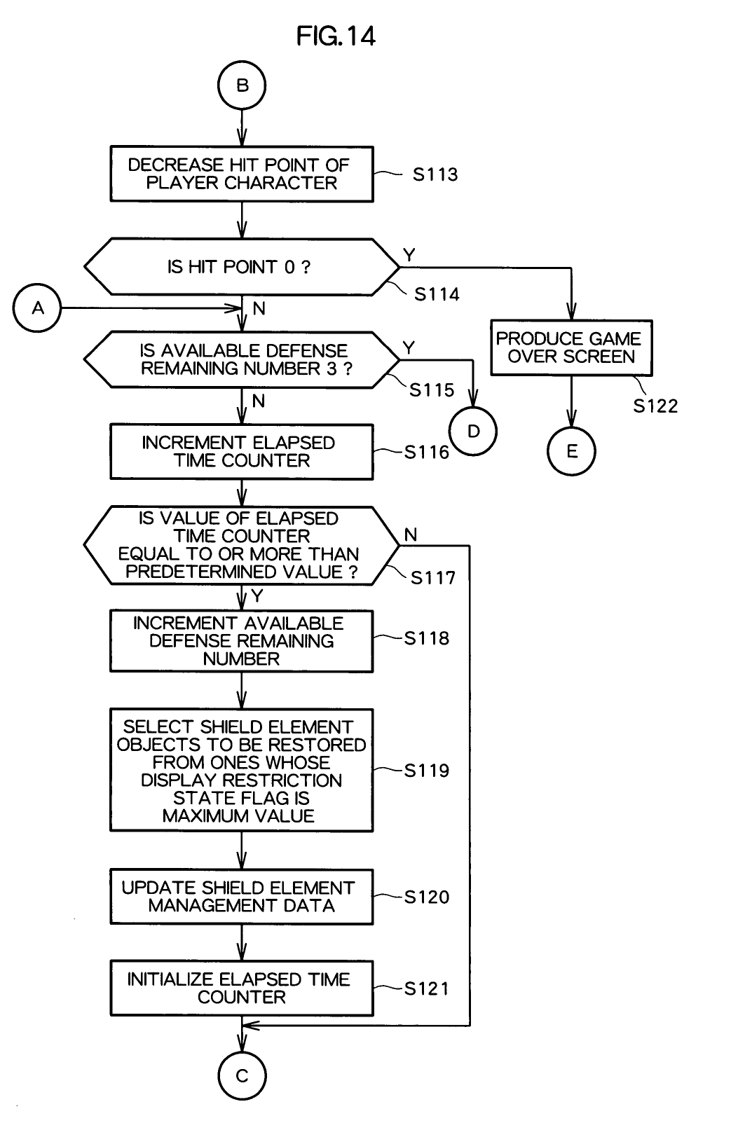

The second determination unit 64 determines whether the increase condition for the available defense remaining number is satisfied or not. The second determination unit 64 stores an elapsed time counter as shown in FIG. 12. The count of the elapsed time is numerical information on a time represented by 1/60 seconds, for example, which has elapsed since the (last) increase/decrease of the available defense remaining number. The increase condition for the available defense remaining number is whether the count of the elapsed time counter has reached a predetermined number or not. If the second determination unit 64 determines that the increase condition for the available defense remaining number is satisfied, the second determination unit 64 increases the available defense remaining number stored in the available defense remaining number storage unit 72 by one. A detailed description will be given later (refer to steps S116 to S118 in FIG. 14).

### [3. Display Restriction Unit]

The display restriction unit 66 selects at least one of the shield element objects 54 (element images) shown on the game screen based on random numbers. This selection is carried out according to the determination result of the first determination unit 62. In other words, the selection is carried out according to the occurrence of the event making the offence of the enemy character ineffective. Specifically, the selection is carried out according to the update of the available defense remaining number carried out by the first determination unit 62. It should be noted that the number of shield element objects 54 which is selected based on random numbers by the display restriction unit 66 may correspond to the change amount (decrease amount) of the available defense remaining number.

The display restriction unit 66 restricts the display of the selected shield element objects 54 on the game screen. For example, the display restriction unit 66 sets the degree of transparency (alpha value) of the selected shield element objects 54 so that the selected shield element objects 54 are transparent. According to this embodiment, the display restriction unit 66 updates the value of the display restriction state flag of the selected shield element objects 54 to either one, two, or three based on the current available defense remaining number. A detailed description will be given later (refer to steps S106, S108, and S111 in FIG. 14).

### [4. Display Restriction Resetting Unit]

The display restriction resetting unit 68 resets the display restriction applied by the display restriction unit 66 based on the display restriction state flag of the shield element management data. The display restriction resetting unit 68 selects at least one of the shield element objects 54 whose display is restricted by the display restriction unit 66 based on the display restriction state flag of the shield element management data. The selection is carried out according to the determination result of the second determination unit 64. In other words, the selection is carried out according to the update of the available defense remaining number carried out by the second determination unit 64. The display restriction resetting unit 68 may carry out the selection further based on random numbers. Moreover, the number of shield element objects 54 which is selected based on random numbers by the display restriction unit 68 may correspond to the change amount (increase amount) of the available defense remaining number.

Moreover, the display restriction resetting unit 68 resets the display restriction applied to the selected shield element objects 54. For example, the display restriction resetting unit 68 sets the degree of transparency (alpha value) of the selected shield element objects 54 so that the selected shield element objects 54 become opaque. According to this embodiment, the display restriction resetting unit 68 updates the value of the display restriction state flag to zero for the selected shield element objects 54. A detailed description will be given later (refer to steps S119 and S120 in FIG. 14).

### [5. Game Image Display Unit]

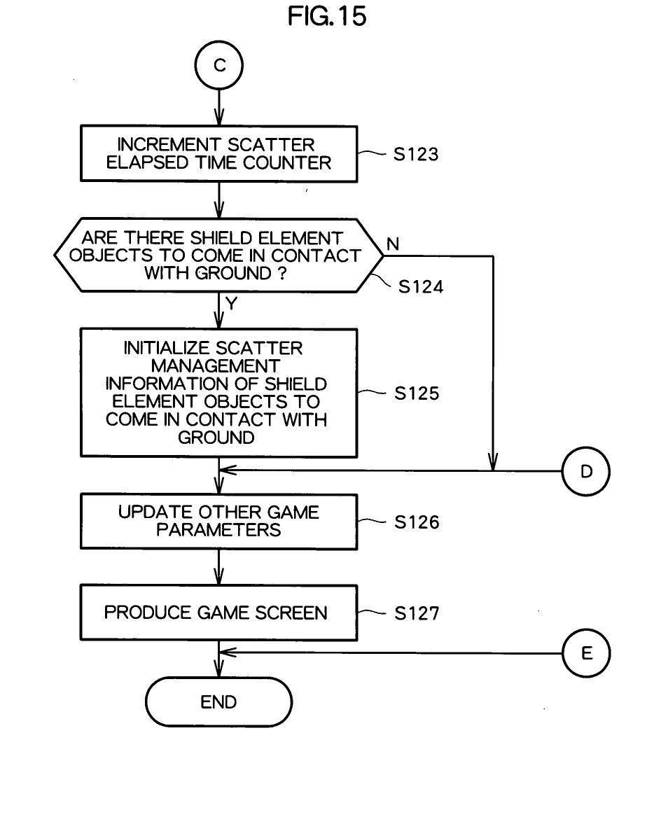

The game image display unit 76 is mainly constituted by the image processing unit 16 and the monitor 18. The game image display unit 76 produces a game image of a scene obtained by viewing, from a given viewpoint, a three dimensional space including the player character 50, the shield element objects 54, the enemy character, and the like, and displays the produced game image on the monitor 18. A detailed description will be given later (refer to a step S127 in FIG. 15).

A description will now be given of a game process carried out every predetermined interval (specifically 1/60 second) on the game device 10. FIGS. 13 to 15 show a flowchart mainly showing a part relating to the game process of the present invention. It should be noted that the process shown in these figures is realized by the program supplied from an information storage medium such as the DVD-ROM 25 (or a communication network) executed by the microprocessor 14.

As shown in FIG. 13, in the game process, the first determination unit 62 determines whether the offence by the enemy character hits the player character 50 or not (S101). In the three-dimensional space, an object for hit determination (such as a sphere or a triangular object) corresponding to the player character 50 is provided. The first determination unit 62 carries out a publicly-known process for determining a hit based on this object for the hit determination and an offense means object of the enemy character. It should be noted that the offense means object includes a part (such as the arm and the foot) of the enemy character object, a weapon object carried by the enemy character, a bullet object represented as being shot from the enemy character, and an object for the hit determination corresponding to them.

If the first determination unit 62 determines that the offense hits the player character 50, the first determination unit 62 determines whether the defense operation is being carried out or not (S102). For example, when an operation to depress a predetermined button (such as the button 42R) on the controller 32 is the defense operation, the first determination unit 62 determines whether an operation signal indicating the operation of the depression of the button is input from the controller 32 or not.

If the first determination unit 62 determines that the defense operation is being carried out, the first determination unit 62 refers to the stored contents of the available defense remaining number storage unit 72, and determines whether the available defense remaining number is zero or not (S103).

If the first determination unit 62 determines that the available defense remaining number is not zero, the first determination unit 62 determines whether the offense against the player character 50 (the offense which is determined that it hit the player character 50) is a special offense or not (S104). As described before, the special offense is an offense which always reduces the available defense remaining number to zero.

If the first determination unit 62 determines that the offense against the player character 50 is not a special offense (is a normal offense), the first determination unit 62 decrements the available defense remaining number stored in the available defense remaining number storage unit 72 (S105).

On this occasion, the display control unit 66 selects the shield element objects 54 to be set to transparent from the shield element objects 54 shown on the game screen (shield element objects 54 which are not set to transparent) (S106). More specifically, the display control unit 66 refers to contents of the shield element management data, and selects nine shield element objects 54 based on random numbers from the shield element objects 54 whose display restriction state flag is zero.

Then, the display restriction unit 66 determines a scatter start speed vector for the respective selected shield element objects 54 (S107). The scatter start speed vector is determined based on a random number. Specifically, the initial speed is determined based on the random number. Moreover, a direction whose angle with respect to a direction from the position of the enemy character whose offense hits the player character 50 to the position of the player character 50 is equal to or less than a predetermined angle is determined based on a random number as a scatter direction.

Then, the display restriction unit 66 updates the contents of the shield element management data based on the determinations in the steps S106 and S107 (S108). Specifically, if the available defense remaining number is two, the display restriction unit 66 updates the display restriction state flag of the shield element objects 54 selected in the step S106 to one. Moreover, if the available defense remaining number is one, the display restriction unit 66 updates the display restriction state flag to two, and if the available defense remaining number is zero, the display restriction unit 66 updates the display restriction state flag to three. Moreover, the display restriction unit 66 updates the scatter start flag of the shield element objects 54 selected in the step S106 to one. Further, the display restriction unit 66 registers the present position of the shield element objects 54 as a scatter start position, and registers the scatter start speed vector determined in the step S107 as a scatter start speed vector.

On the other hand, if the first determination unit 62 determines that the offense against the play character 50 is a special offense in the step S104, the first determination unit 62 updates the available defense remaining number stored in the available defense remaining number storage unit 72 to zero (S109). In this case, the display restriction unit 66 refers to the contents of the shield element management data, and determines the scatter start speed vector for the respective shield element objects 54 whose display restriction state flag is zero (S110). On this occasion, the scatter start speed vector is determined as in the step S107. Then, the display restriction unit 66 updates the shield element management data (S111). Specifically, the display restriction unit 66 updates the display restriction state flag to three for the respective shield element objects 54 whose display restriction state flag is zero. Moreover, the display restriction unit 66 registers the present position of the shield element objects 54 as a scatter start position, and registers the scatter start speed vector determined in the step S110 as a scatter start speed vector.

After the shield element management data is updated in the steps S108 and S111, the second determination unit 64 initializes the elapsed time counter to zero (S112).

If the first determination unit 62 determines that the defense operation is not being carried out in the step S102, or determines that the available defense remaining number is zero in the step S103, the process for decreasing the hit point of the player character 50 is carried out (S113). The amount of decrease of the hit point is determined based on, for example, a defense force parameter of the player character 50, an offense force parameter of the enemy character whose offense hit the player character 50, and a random number. In this case, it is determined whether the hit point of the player character is zero or not (S114). If it is determined that the hit point of the player character 50 is zero, a game over process is carried out and a game over screen is formed in the VRAM (S122). The game over screen formed in the VRAM is output to the monitor 18 in predetermined timing.

Moreover, if the first determination unit 62 determines that the offense does not hit the player character in the step S101, or it is determined that the hit point of the player character is not zero in the step S114, the second determination unit 64 determines whether the available defense remaining number is the maximum available defense number, which is three, or not (S115). If the second determination unit 64 determines that the available defense remaining number is not three, the second determination unit 64 increments the elapsed time counter (refer to FIG. 12) (S116).

Then, the second determination unit 64 determines whether the value of the elapsed time counter is equal to or more than a predetermine value or not (S117). If the second determination unit 64 determines that the value of the elapsed time counter is equal to or more than the predetermined value, the second determination unit 64 increments the available defense remaining number stored in the available defense remaining number storage unit 72 (S118).

In this case, the display restriction resetting unit 68 refers to the contents of the shield element management data, and acquires the maximum value of the display restriction state flags. Then, the display restriction resetting unit 68 selects nine shield element objects 54 from the shield element objects 54 whose display restriction state flag has the maximum value, namely the shield element objects 54 which were set to transparent last (S119). On this occasion, if the number of the shield element objects 54 whose display restriction state flag has the maximum value is equal to or more than nine, the nine shield element objects 54 may be selected based on random numbers. After the display restriction resetting unit 68 has selected the nine shield element objects 54, the display restriction resetting unit 68 updates the shield element management data (S120). Specifically, the display restriction resetting unit 68 updates the display restriction state flag of the shield element objects 54 selected in the step S119 to zero. Moreover, the display restriction resetting unit 68 initializes the elapsed time counter to zero (S121).

Though the display restriction is reset (the display restriction state flag is returned to zero) sequentially starting from the shield element objects 54 whose display was restricted (set to transparent) last, the display restriction may be reset sequentially starting from the shield element objects 54 whose display was restricted first.

Moreover, though the display restriction resetting unit 68 selects the nine shield element objects 54 at once, and updates the display restriction state flag of the selected shield element objects 54 to zero, the selection and the update may be carried out several times. For example, if the selection and the update are to be carried out three times, three shield element objects 54 are sequentially selected each time based on random numbers, and the display restriction flag of the selected shield element objects 54 is updated to zero. In this way, it is possible to more properly express the shield object 52 gradually getting restored on the game screen.

After the step S112 or S121 has been executed, or if it is determined that the value of the elapsed time counter is less than the predetermined value in the step S117, the determination unit 60 refers to the contents of the shield element management data, and increments the value of the scatter elapsed time counter of the respective shield element objects 54 whose scatter state flag is one (S123). Then, it is determined whether the scatter effect objects which correspond to shield element objects 54 whose scatter state flags are one are in contact with the ground object 48 or not (S124). Specifically, for the respective shield element objects 54 whose scatter state flags are one, the present position of the scatter effect object corresponding the shield element object 54 is calculated based on the scatter start position, the scatter start speed vector, and the scatter elapsed time counter, and it is determined whether the scatter effect object is in contact with the ground object 48 or not.

Then, if the determination unit 60 determines that the scatter effect object comes in contact with the ground object 48, the determination unit 60 initializes the scatter management information of the shield element object 54 corresponding to the scatter effect object (S125). Specifically, the determination unit 60 updates the scatter state flag to zero, and initializes the scatter start position, the scatter start speed vector, and the scatter elapsed time counter.

Then, the determination unit 60 carries out update processes for the other game parameters (S126). For example, the determination unit 60 updates parameter information indicating the position of the player character 50 according to a move instruction operation by the player.

When the above process has been completed, the game image display unit 76 produces a game screen (S127). In this case, shield element objects 54 whose display restriction state flags are zero are set to opaque, and shield element objects 54 whose display restriction state flags are not zero are set to transparent. Moreover, even shield element objects 54 whose display restriction flags are zero are set to transparent if the image display unit 76 determines that the player is not carrying out the defense operation. Further, for shield element objects 54 whose scatter state flags are one, scatter effect objects are placed at positions in the three dimensional game space calculated based on scatter start positions, scatter start speed vectors, and scatter elapsed time counters. A game image of a scene obtained by viewing, from a given viewpoint, “the game space where the shield element objects 54, the scatter effect objects, other objects such as the player character 50 or the enemy character are arranged” is formed in the VRAM. The game screen formed in the VRAM is output to the monitor 18 at a predetermined timing.

As described above, in the three-dimensional action game provided by the game device 10, it is necessary to operate the player character while considering the available defense remaining number. However, on the game device 10, the shield object 52, which is damaged according to the decrease of the available defense remaining number and is restored according to the increase of the available defense remaining number, is displayed close to the player character 50. Therefore, the player can recognize the available defense remaining number at a glance during the operation while paying attention to the player character 50.

Moreover, on the game device 10, the shield object 52 is not damaged in the same manner every time, so as not to bore the player. Further, on the game device 10, though the shield object 52 is not made to be always damaged in the same manner, and the gradual recovery state of the shield object 52 is properly expressed.

It should be noted that the present invention is not limited to the above-described embodiment.

For example, though the shield object 52 is damaged according to the decrease of the available defense remaining number, and the shield object 52 may be restored according to the increase of the available defense remaining number, the shield object 52 may be damaged according to an increase of another numerical parameter, and the shield object 52 may be restored according to the decrease of this numerical parameter.

Moreover, the display restriction may be set to all the shield element objects 54 in advance, and at least one of the shield element objects 54 is selected according to an increase (decrease) of a predetermined numerical parameter, and the display restriction of the selected shield element object 54 may be reset. In this case, sequence information which indicates the sequence of the reset of the display restriction of the shield element object 54 whose display restriction is reset may be retained in association with this shield element object 54. Then, at least one of the shield element objects 54 whose display restriction may be reset according to the decrease (increase) of the predetermined numerical parameter may be selected, and the display restriction may be set again to the selected shield element object 54. In this case, the selection of the shield element object 54, and the set and reset of the display restriction may be carried out in a manner similar to that of the above-described embodiment.

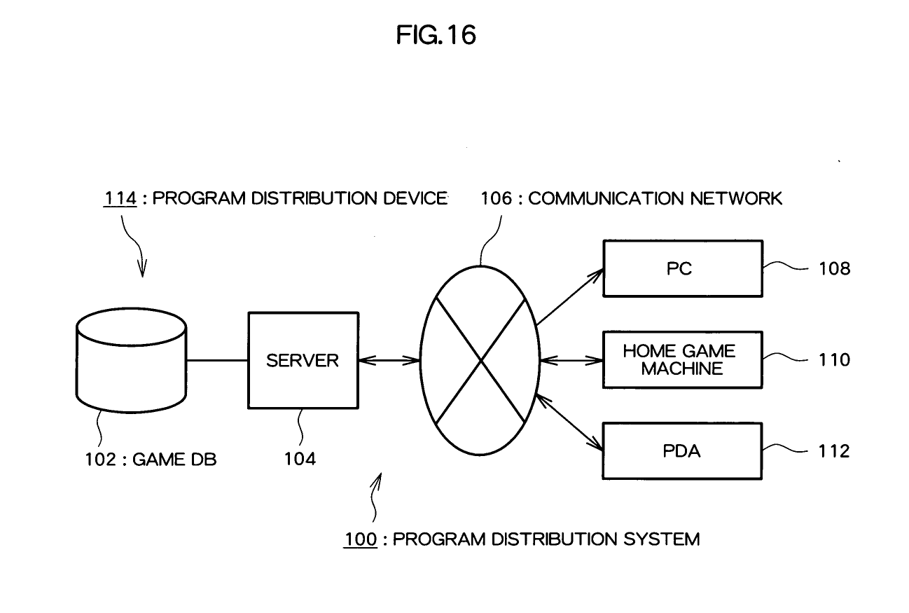

Although it is described in the above that a program is supplied from the DVD-ROM 25, or an information storage medium, to the home game machine 11, alternatively, the program may be distributed to a household or the like via a communication network. FIG. 16 shows an overall structure of a program distribution system via a communication network. A description will now be given of a program distribution method according to the present invention with reference to this figure. As shown in the figure, this program distribution system 100 includes a game database 102, a sever 104, a communication network 106, a PC 108, a home game machine 110, and a PDA (personal digital assistant) 112. The program distribution device 114 is constituted by the game database 102 and the server 104. The communication network 106 is constituted by including the Internet, and a cable television network, for example. In this system, the game database (information storage medium) 102 stores the program which is the same as the stored contents of the DVD-ROM 25. Then, if a consumer requests game distribution by means of the PC 108, the home game machine 110, the PDA 112, or the like, the game distribution request is transmitted to the server 104 via the communication network 106. Then, the server 104 reads out a program from the game database 102 according to the game distribution request, and transmits the program to the game distribution request source such as the PC 108, the home game device 110, and the PDA 112. Though a game is distributed according to the game distribution request, the game may be transmitted from the server 104 independently of the request. Moreover, it is not necessary to distribute an entire program required for providing a game at once (entire distribution), and a part of the program may be distributed according to a scene of the game (partial distribution) When a game is distributed via the communication network 106 in this way, the consumer can easily obtain the program.

1. A game device for displaying an image including a plurality of element images on a game screen, comprising:
display restriction means for selecting at least one of the element images shown on the game screen based on a random number in response to an occurrence of a predetermined game event, and restricting display of the selected element image;
sequence information storage means for storing sequence information indicating a sequence of the restriction of the element image whose display is restricted by the display restriction means in association with the element image; and
display restriction resetting means for resetting the display restriction by the display restriction means based on the sequence information stored in the sequence information storage means.

2. A game device according to claim 1, wherein the display restriction resetting means resets the display restriction by the display restriction means based on a random number.

3. A game device according to claim 1, further comprising numerical information storage means for storing numerical information which is decreased in response to an occurrence of the predetermined game event, wherein:
the display restriction means selects at least one of the element images shown on the game screen according to a decrease of the numerical information based on a random number, and restricts display of the selected element image; and
the display restriction resetting means resets the display restriction by the display restriction means according to an increase of the numerical information.

4. A game device according to claim 1, further comprising numerical information storage means that stores numerical information which is increased in response to an occurrence of the predetermined game event, wherein:
the display restriction means selects at least one of the element images shown on the game screen according to an increase of the numerical information based on a random number, and restricts display of the selected element image; and
the display restriction resetting means resets the display restriction by the display restriction means according to a decrease of the numerical information.

5. A game device according to claim 3, or claim 4, wherein the number of element images which are selected from element images shown on the game screen based on a random number by the display restriction means corresponds to the increase or the decrease of the numerical information.

6. A game device according to claim 1, wherein:
an operation object image is shown on the game screen; and
the image is shown at a position based on a position of the operation object image.

7. A control method for a game device for displaying an image including a plurality of element images on a game screen, comprising:
a display restriction step of selecting at least one of the element images shown on the game screen based on a random number in response to an occurrence of a predetermined game event, and restricting display of the selected element image;
a step of storing sequence information indicating a sequence of the restriction of the element image whose display is restricted by the display restriction step in storage means in association with the element image; and
a display restriction resetting step of selecting at least one of the element images whose display is restricted by the display restriction step based on the sequence information stored in the storage means, and resetting the display restriction applied to the element image.

8. A computer-readable information storage medium storing a program for causing a computer to function as a game device for displaying an image including a plurality of element images on a game screen, causing the computer to function as:
display restriction means for selecting at least one of the element images shown on the game screen according to a random number in response to an occurrence of a predetermined game event, and restricting display of the selected element image;
sequence information storage means for storing sequence information indicating a sequence of the restriction of the element image whose display is restricted by the display restriction means in association with the element image; and
display restriction resetting means for resetting the display restriction by the display restriction means based on the sequence information stored in the sequence information storage means.

9. A game device according to claim 4, wherein the number of element images which are selected from element images shown on the game screen based on a random number by the display restriction means corresponds to the increase or the decrease of the numerical information.

10. A game device according to claim 2, wherein:
an operation object image is shown on the game screen; and the image is shown at a position based on a position of the operation object image.

11. A game device according to claim 3, wherein:
an operation object image is shown on the game screen; and the image is shown at a position based on a position of the operation object image.

12. A game device according to claim 4, wherein:
an operation object image is shown on the game screen; and the image is shown at a position based on a position of the operation object image.
